(19) United States
(12) Patent Application Publication
(10) Pub. No.: US 2007/0063144 A1
(43) Pub. Date: Mar. 22, 2007

(54) Method for treating products

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/411,508

(22) Filed: Apr. 26, 2006

(30) Foreign Application Priority Data
Sep. 16, 2005 (CN) 200510037343.6

(51) Int. Cl. G01F 23/00

(52) U.S. Cl. 250/358.1

(57) ABSTRACT

A method for treating product includes the steps of: placing the product to be treated in an atmosphere kept at a temperature of 10 degree C. to 30 degree C., and with a humidity of 20% to 60%; providing a gamma ray source that can emit gamma ray; exposing the product to the gamma ray. The gamma ray is a kind of microcosmic particle flow with high energy, and it is a carrier of energy and substance. When the gamma ray acts on material of the product, various physical and chemical effects can be generated. The generated effects can cause the ingredient, configuration and performance of the surface of the product to change. Thus, the surface of the product is optimized.

### BACKGROUND

1. Field of the Invention

The present invention relates to a method for treating products and, more particularly, to a method using gamma ray to treat various products.

2. Discussion of the Related Art

Electronic products such as computers, communication products and consumptive products are becoming more widely used. In order to satisfy visual requirements of consumers, outer casings of these products generally need to be treated by some methods such as spray coating method, paster method, and in-mold decoration method, etc.

The spray coating method is to spray coating material on a surface of an outer casing and thereby form a coating layer. The paster method is to paste a layer of paper on a surface of an outer casing. The products respectively treated by the two methods can achieve desirable performances such as protection, beautification, or smoothness, etc. However, after the products are used for a period of time, the coating layer is easy to be worn away, and the pasted paper is easy to fall off. Thus, appearances of the products are not beautiful any more, and are adversely influenced.

In-mold decoration method generally includes following steps: mounting a film with printed pattern or letters in a molding chamber of a mold; injecting plastic material in the molding chamber, and making the film firmly combine with the molded product together. Because the combination between the film and the molded product is firm, the in-mold decoration method can achieve a surface with excellent performances. However, this method has following disadvantages. The making time of the film is long. The mold used in this method needs high positioning accuracy. The process is complicated, and the cost of the product is increased. In addition, this method usually can only treat products made from plastic material.

What is needed, therefore, is a method that can treat various products.

### SUMMARY

A method for treating a product according to one preferred embodiment includes the steps of: placing the product to be treated in an atmosphere kept at a temperature of 10 degree C. to 30 degree C., and with a humidity of 20% to 60%; providing a gamma ray source that can emit gamma ray; exposing the product to the gamma ray. The present method can treat various products.

Other advantages and novel features will become more apparent from the following detailed description of present method.

### DETAILED DESCRIPTION OF PREFERRED EMBODIMENTS

A method for treating a product in accordance with a preferred embodiment includes the steps of: placing the product to be treated in an atmosphere kept at a temperature of 10 degree C. to 30 degree C., and with a humidity of 20% to 60%; providing a gamma ray source that can emit gamma ray; exposing the product to the gamma ray The gamma ray source can be Co-60, Cs-134, or Cs-137. The energy of the emitted gamma ray is in the approximate range of from 100 KeV to 3000 KeV, and preferably is about in the range from 500 KeV to 1500 KeV.

The foregoing method is suitable for treating various products made from metal alloy, composite material, plastic material, bamboo, wood, glass, ceramic, or glass-ceramic, etc. Preferably, the method is suitable for treating surface layers of products.

The following examples illustrate selected detailed embodiments to practice the present method.

### EXAMPLE 1

With respect to a product made of bamboo, the method for treating it includes the steps of placing the bamboo product to be treated in an atmosphere kept at a temperature of 10 degree C. to 30 degree C., and with a humidity of 20-60%; providing a Co-60 to emit gamma ray with energy of 100 KeV to 3000 KeV and a dose rate of 100 Kgy/s to 3000 Kgy/s; exposing the bamboo product to the gamma ray for about 1 minute to 10 minutes. Before the bamboo material is treated by gamma ray, it has high flexility and high bend strength. After the bamboo material is treated by gamma ray, its surface layer achieves high hardness, high density, and high durability.

### EXAMPLE 2

With respect to a product made from glass, the method for treating it includes the steps of placing the glass product to be treated in an atmosphere kept at a temperature of 10 degree C. to 30 degree C., and with a humidity of 20-60%; providing a Co-60 to emit gamma ray with energy of 100 KeV to 3000 KeV and a dose rate of 100 Kgy/s to 3000 Kgy/s; exposing the glass product to the gamma ray for about 1 hour to 2 hours. Before the glass product is treated by gamma ray, the silicon dioxide contained therein is amorphous. After the glass product is treated by gamma ray, the silicon dioxide can change its inter-atomic distance of Si—Si, Si—O, and O—O. Thus, the glass product becomes microcrystalline, and its color is changed from transparency to pink color. This color is beautiful to look at, and is favorable.

Comparing with conventional treating methods, the present method has following advantages. The gamma ray is a kind of microcosmic particle flow having high energy, and it is a carrier of energy and substance. When the gamma ray acts on material of products, various physical and chemical effects can be generated. The generated effects can cause the ingredient, configuration and performance of the surface layer of the product to change. Thus, the surface layer of the product is optimized.

It is to be understood that the above-described embodiments are intended to illustrate rather than limit the invention. Variations may be made to the embodiments without departing from the spirit of the invention as claimed. The above-described embodiments are intended to illustrate the scope of the invention and not restrict the scope of the invention.

What is claimed is:

1. A method for treating a product, comprising the steps of
providing the product to be treated; and
using gamma ray to irradiate the product.

2. The method as claimed in claim 1, wherein the product is placed in an atmosphere kept at a temperature of 10 degree C. to 30 degree C., and with a humidity of 20% to 60%.

3. The method as claimed in claim 1, wherein the gamma ray is emitted from a gamma ray source selected from the group consisting of Co-60, Cs-134, and Cs-137.

4. The method as claimed in claim 1, wherein the energy of the gamma ray is in the approximate range of from 100 KeV to 3000 KeV.

5. The method as claimed in claim 4, wherein the energy of the gamma ray is about in the range from 500 KeV to 1500 KeV.

6. The method as claimed in claim 3, wherein the gamma ray is emitted from Co-60, the gamma ray has energy of 100 KeV to 3000 KeV and a dose rate ranging from 100 Kgy/s to 3000 Kgy/s.

7. The method as claimed in claim 1, wherein the material of the product is comprised of one of metal alloy, composite material, plastic material, bamboo, wood, glass, ceramic, and glass-ceramic.

8. The method as claimed in claim 7, wherein the material of the product is bamboo, and the irradiating time is about 1 minute to 10 minutes.

9. The method as claimed in claim 7, wherein the material of the product is glass, and the irradiating time is about 1 hour to 2 hours.

10. A method for treating a product, comprising the steps of:
placing the product in an atmosphere kept at a temperature of 10 degree C. to 30 degree C., and with a humidity of 20% to 60%;
providing a gamma ray source and emitting gamma ray from the gamma ray source; and
exposing the product to the gamma ray.

11. The method as claimed in claim 10, wherein the gamma ray source is selected from the group consisting of Co-60, Cs-134, and Cs-137.

12. The method as claimed in claim 10, wherein the energy of the gamma ray is in the approximate range of from 100 KeV to 3000 KeV.

13. The method as claimed in claim 12, wherein the energy of the gamma ray is about in the range from 500 KeV to 1500 KeV.

14. The method as claimed in claim 11, wherein the gamma ray is emitted from Co-60, the gamma ray having energy ranging from 100 KeV to 3000 KeV and a dose rate of 100 Kgy/s to 3000 Kgy/s.

15. The method as claimed in claim 10, wherein the material of the product is comprised of one of metal alloy, composite material, plastic material, bamboo, wood, glass, ceramic, and glass-ceramic.

16. The method as claimed in claim 15, wherein the material of the product is bamboo, and the irradiating time is about 1 minute to 10 minutes.

17. The method as claimed in claim 15, wherein the material of the product is glass, and the irradiating time is about 1 hour to 2 hours.

18. A method for treating a product, comprising the steps of:
providing an outer casing of the product;
providing a gamma ray source and aiming it at a surface of the outer casing;
operating the gamma ray source to emit gamma ray; and
irradiating the gamma ray on the surface of the product.
